(19) United States
(12) Patent Application Publication
(10) Pub. No.: US 2007/0018140 A1
(43) Pub. Date: Jan. 25, 2007

(54) Metal nanoparticles and method for producing the same

(75) Inventors: Young-Il Lee, Anyang-si (KR); Hye-Jin Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/488,641

(22) Filed: Jul. 19, 2006

(30) Foreign Application Priority Data
Jul. 22, 2005 (KR) 10-2005-0066926

(51) Int. Cl. H01B 1/12

(52) U.S. Cl. 252/500

(57) ABSTRACT

A method of producing metal nanoparticles, having a high yield rate achieved by a simple heat-treatment of a metal alkanoate. The method of the invention is not only environment-friendly as it does not require additional solvents or supplements, but also economical as highly expensive equipment is not demanded. In addition, the invention provides metal nanoparticles having uniform shape and distribution, and provides conductive ink including the metal nanoparticles thus obtained. One aspect may provide a method of (a) producing a metal alkanoate by reacting a metal precursor with an alkanoate of alkali metals, alkaline earth metals or ammonium in an aqueous solution (b) filtrating and drying the metal alkanoate, and (c) heat-treating the metal alkanoate of (b).

### CROSS-REFERENCE TO RELATED APPLICATIONS

This application claims the benefit of Korean Patent Application No. 10-2005-0066926 filed on Jul. 22, 2005, with the Korea Intellectual Property Office, the contents of which are incorporated here by reference in their entirety.

### BACKGROUND

1. Technical Field

The present invention relates to a method of producing metal nanoparticles.

2. Description of the Related Art

General ways to produce metal nanoparticles are the vapor-phase method, the solution (colloid) method and a method using supercritical fluids. Among these methods, the vapor-phase method using plasma or gas evaporation is generally capable of producing metal nanoparticles with the size of several tens of nm, but has limitation in synthesizing small-sized metal nanoparticles of 30 nm or less. Also, the vapor-phase method has shortcomings in terms of solvent selection and costs, particularly, in that it requires highly expensive equipments.

The solution method including thermal reduction and phase transfer method is capable of adjusting various sizes of metal nanoparticles, synthesizing several nm sizes of metal nanoparticles having uniform shape and distribution. However, the production of metal nanoparticles by this existing method provides very low yield rate, as it is limited by the concentration of the metal compound solution. That is, it is possible to form metal nanoparticles of uniform size only when the concentration of the metal compound is less than or equal to 0.01M. Thus, there is a limit also on the yield of metal nanoparticles, and to obtain metal nanoparticles of uniform size in quantities of several grams, 1000 liters or more of functional group are needed. This represents a limitation to efficient mass production. Moreover, the phase transfer method necessarily requires a phase transfer, which is a cause of increased production costs.

### SUMMARY

The present invention was accomplished taking into account of the problems as described above. The present invention provides a method of producing metal nanoparticles, having a high yield rate achieved by a simple heat-treatment of metal alkanoate. The method of the present invention is not only environment-friendly as it does not require additional solvents or supplements, but also economical as highly expensive equipments are not demanded.

In addition, the invention provides metal nanoparticles having uniform shape and distribution, and provides conductive ink including the metal nanoparticles thus obtained.

Additional aspects and advantages of the present invention will be set forth in part in the description which follows and, in part, will be obvious from the description, or may be learned by practice of the invention.

One aspect of the invention may provide a method of producing nanoparticles comprising, (a) producing a metal alkanoate by reacting a metal precursor with an alkanoate of an alkali metal, an alkaline earth metal or an ammonium in an aqueous solution (b) filtrating and drying the metal alkanoate and (c) heat-treating of the metal alkanoate of (b).

Here, the alkanoate of alkali metals, alkaline earth metals and ammonium may be one or more alkanoate selected from a group consisting of Na-alkanoate, K-alkanoate, Ca-alkanoate and NH₃-alkanoate. According to a preferred embodiment, the alkanoate of alkali metal, alkaline earth metal or ammonium is an alkanoate which has C₈-C₁₈.

Here, the metal precursor may be a compound including one or more metals selected from a group consisting of gold, silver, copper, platinum, lead, indium, palladium, rhodium, ruthenium, iridium, osmium, tungsten, nickel, tantalum, bismuth, tin, zinc, titanium, aluminum, cobalt, iron and a mixture thereof. In a preferred embodiment, the metal precursor is one or more compound selected from a group consisting of AgNO₃, AgBF₄, AgPF₆, Ag₂O, CH₃COOAg, AgCF₃SO₃ and AgClO₄.

In addition, it is preferable that heat-treatment be performed at 180 to 350° C. for 0.5 to 4 hours using one chosen from a vacuum oven, a muffle furnace, or a convection oven, and in nitrogen gas or in the air with airtight state.

Another aspect of the invention may provide metal nanoparticles having alkanoate chain which is obtained by the method of producing the metal nanoparticles. Here, 3 to 10 nm size of metal nanoparticles may be obtained.

Still another aspect of the invention may provide a conductive ink including metal nanoparticles.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a graph representing the results of UV spectroscopy for the metal nanoparticles produced according to an embodiment of the invention;

FIG. 2 is a graph representing the results of X ray diffraction assay for the metal nanoparticles produced according to an embodiment of the invention; and

FIGS. 3 to 7 are TEM images of the metal nanoparticles produced according to preferred embodiments of the invention.

### DETAILED DESCRIPTION

Hereinafter, preferred embodiments will be described in detail of the method of producing metal nanoparticle and the metal nanoparticles thus produced according to the present invention.

Any compound including metals, as generally used in the production of metal nanoparticles, may be used as a metal precursor in the present invention. Preferably, examples of such a metal precursor may include at least one metal selected from a group consisting of gold, silver, copper, platinum, lead, indium, palladium, rhodium, ruthenium, iridium, osmium, tungsten, nickel, tantalum, bismuth, tin, zinc, titanium, aluminium, cobalt, iron and a mixture thereof. Specific example of the metal precursor may be inorganic acid salts such as nitrate, carbonate, chloride, phosphate, borate, oxide, sulfonate, and sulfate and organic acid salts such as stearate, myristate, and acetate. The use of nitrates may be more preferable, as they are economical and widely used. More specific examples of the metal precursor of silver may include silver precursors such as of AgNO₃, AgBF₄, AgPF₆, Ag₂O, CH₃COOAg, AgCF₃SO₃ and AgClO₄, and copper precursors such as of Cu(NO₃), CuCl₂, CuSO₄, and nickel precursors such as of NiCl₂, Ni(NO₃)₂, and NiSO₄, etc.

Any alkanoate compound which has RCOO⁻ group and thus readily form a metal alkanoate complex by reacting with such metal precursors, may be used without limitation. In this case, R may be a substituted or unsubstituted saturated or unsaturated hydrocarbon. According to a preferred embodiment, the carbon number of alkanoate preferably ranges from 8 to 18. Preferred examples of this alkanoates, not limited to these examples, may be alkanoate compounds including alkali metals such as Li, Na, and K, alkanoate compounds including alkali earth metals such as Mg and Ca and alkanoate compounds including NH₃. Among these compounds, Na-alkanoate (CₙH₂ₙ₊₁COONa) is generally more preferable, as it forms a complex easily.

The Na-alkanoate may be produced by reacting NaOH with alkanoic acid or amine-based compound which has various numbers of carbon atoms, preferably ranging from C8 to C18. For example, an alkanoic acid such as dodecanoic acid (lauric acid, C₁₁H₂₃COOH), oleic acid (C₁₇H₃₃COOH), hexadecanoic acid (palmitic acid, C₁₅H₃₃COOH), and tetradecanoic acid (myristic acid, C₁₃H₂₇COOH), etc. may be used to produce Na-alkanoate. This may be used to prepare other alkanoates of alkali metals, alkali earth metals, and ammonium. In preferred embodiment, Na-alkanoate may be obtained by reacting an alkanoic acid dissolved in a hydrophilic solvent such as methanol with NaOH dissolved in distilled water. Further, as well as sodium oleate, already commercialized alkali metal alkanoate, alkali earth metal alkanoate, and ammonium alkanoate may also be used.

It is preferred that the alkali metal, alkali earth metal, or ammonium alkanoate thus produced be mixed with the metal precursor in an equivalent molar ratio, since a 1:1 substitutive reaction occurs between them. An additional use of one in a higher ratio than the other will result in the formation of by-product that is not involved in the reaction and it is therefore not preferable. The reaction is preferably performed at a range of the room temperature to 70° C. for 0.5 to 2 hours. Since in this range the metal alkanoate may be produced most economically, the higher temperature than this maximum temperature does not promote a faster reaction, so that the yield rate is not increased.

The metal alkanoate complex obtained from the reaction is precipitated out as a white or pale yellow colored precipitates, which are further filtered and dried to produce the metal alkanoate in solid powder. During the procedure, cleaning in an organic solvent such as methanol or ethanol may shorten the time for drying.

After putting the dried solid metal alkanoate complex in a container and heating at 180° C. to 350° C. for 0.5 to 4 hours, metal nanoparticles may be obtained by the pyrolysis of the metal alkanoate complex. Since the complex is pyrolyzed at a temperature of 230° C. to 340° C., it is preferable that a heat-treatment be performed within this temperature range in case of the heat-treatment for a short period of time. It is preferred that the heat-treatment be performed with a vacuum oven, a muffle furnace, or a convection oven, and Pyrex glass wares be used as a container. Here, according to the conditions, Pyrex wares may be heat-treated being opened or sealed up under nitrogen gas or air. After the heat-treatment, a metal nanoparticle product that is black and viscous liquid or solid may be retrieved. Unless such heat-treatment conditions are appropriate, all of the metal nanoparticles may be pyrolyzed, so that care is demanded.

The metal nanoparticles thus retrieved may further proceed through a step of washing with an organic solvent such as ethanol or methanol and removing the unreactant by centrifugation. On the surface of the metal nanoparticles formed by the present invention, various alkanoate chains that may function as a surfactant, are adsorbed, so that the metal nanoparticles are readily dispersed in a non-aqueous organic solvent such as toluene. Thus, the metal nanoparticles produced by the method of the invention are stable in the re-dispersion step, which allows the metal nanoparticles to be maintained at a high concentration and to have advantage in terms of economy. It is also environment-friendly, since neither a catalyst required for a reduction nor other supplements are demanded. The metal nanoparticles thus formed may be used as conductive ink after adding diverse supplements.

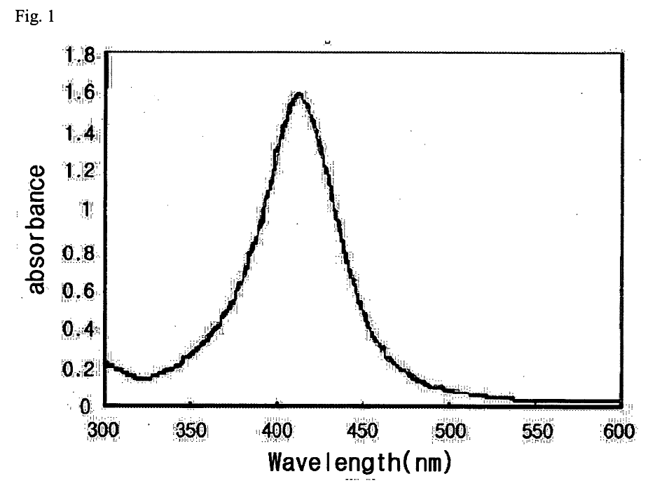

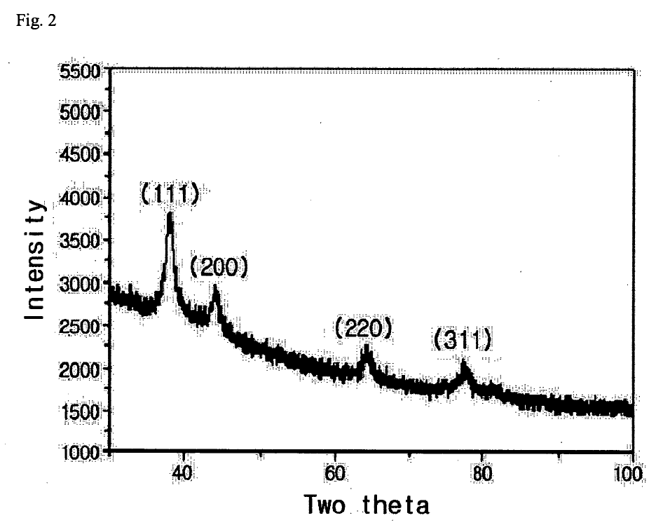

FIG. 1 is a UV spectrum for metal nanoparticles produced according to an embodiment of the invention. Referring to FIG. 1, it is seen that silver nanoparticles obtained by a production method according to the present invention have a typical light absorbance in the wavelength region of 420 nm. In addition, FIG. 2 is a result of X ray diffraction analysis of the metal nanoparticles produced according to a preferred embodiment of the invention. Referring to FIG. 2, the diffraction peak of silver was observed at the degree of 38.2°, 44.5°, 64.5° as indicated as (111), (200), (220), which ensures that silver without impurities was produced. The metal nanoparticles thus produced have uniform size distribution of 3 to 10 nm.

The method of producing metal nanoparticles and metal nanopartcles thus produced were set forth above in detail, and hereinafter, explanations will be given in greater detail with specific examples. While the embodiment of the present invention provides the production of silver nanoparticles, the invention is not limited to the examples stated below and may be used for production of another metal nanoparticles. It is also apparent that more changes may be made by those skilled in the art without departing from the principles and spirit of the present invention.

### EXAMPLE 1

0.03M of NaOH solution dissolved in 40 ml of distilled water was added to 0.03M of lauric (dodecanoic) acid solution dissolved in 40 ml of methanol and agitated for 30 minutes. Here 0.03M of AgNO₃ solution dissolved in 40 ml of distilled water was mixed gently to obtain white silver-dodecanoate precipitate. After isolating by filtration, the precipitate was washed with distilled water and methanol, followed by drying at 50° C. for 12 hours. The solid silver-dodecanoate complex was deposited in a Pyrex ware and heated to 190° C. for 3 hours in a vacuum oven, to produce silver nanoparticles.

As shown in FIG. 1, the result of UV measurement presents the typical absorbance peak around 420 nm range, which appears when silver nanoparticles are generated.

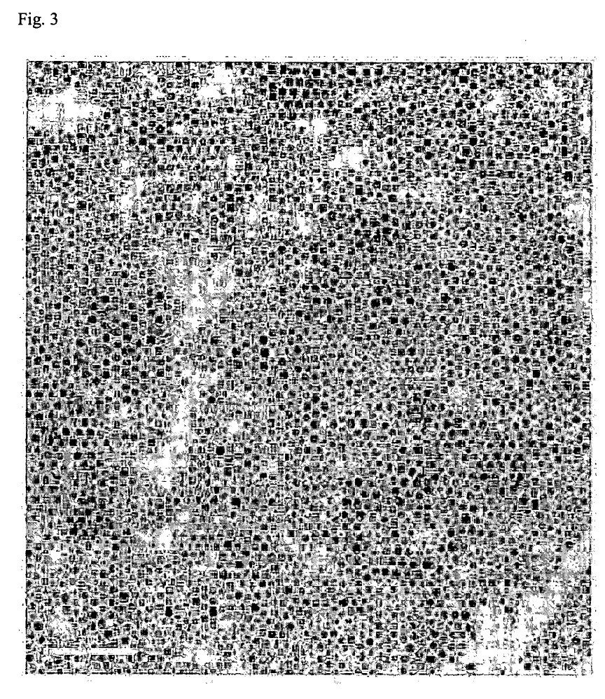

In FIG. 2, the result of X ray diffraction analysis shows that the diffraction peak was observed at the degree of 38.2°, 44.5°, 64.5° as indicated as (111), (200), (220), which ensures that silver without impurities was produced. The result of TEM analysis in FIG. 3 shows that silver nanoparticles having spherical shape and uniform size distribution with a range of 4 to 8 nm were generated.

### EXAMPLE 2

After 0.03M of AgNO₃ was dissolved in 300 ml of distilled water, sodium oleate was added and agitated for 1 hour to precipitate bright ivory colored silver-oleate. Then isolated by filtration, the precipitate was washed with distilled water and methanol, followed by drying at 50° C. for 12 hours. The solid silver-oleate complex was deposited in a Pyrex ware and heated to 270° C. for 1 hour in a muffle furnace, to produce silver nanoparticles.

The generation of silver nanoparticles was confirmed by the UV measurement as shown in FIG. 1, and the production of silver nanoparticles was confirmed by the X ray diffraction assay as shown in FIG. 2.

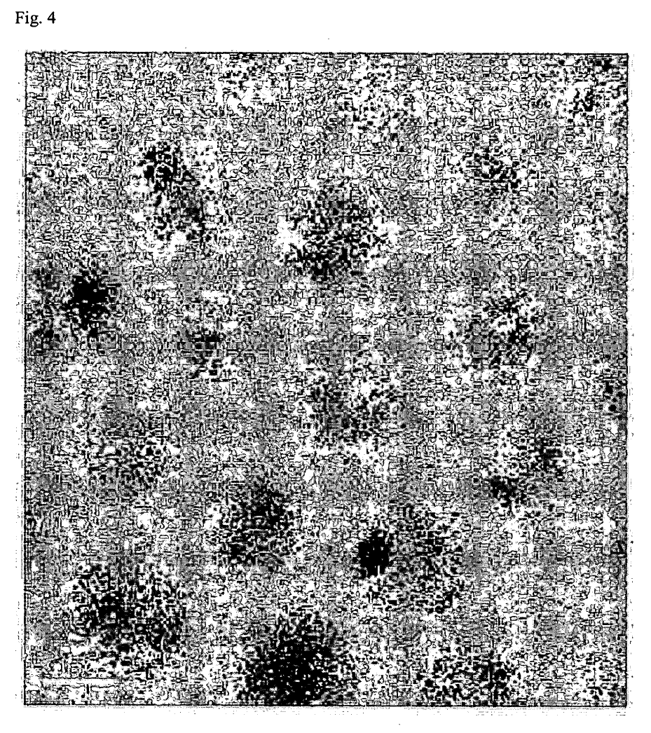

The result of TEM analysis of FIG. 4 ensures that silver nanoparticles having spherical shape and uniform size distribution with a range of 6 to 8 nm were generated.

### EXAMPLE 3

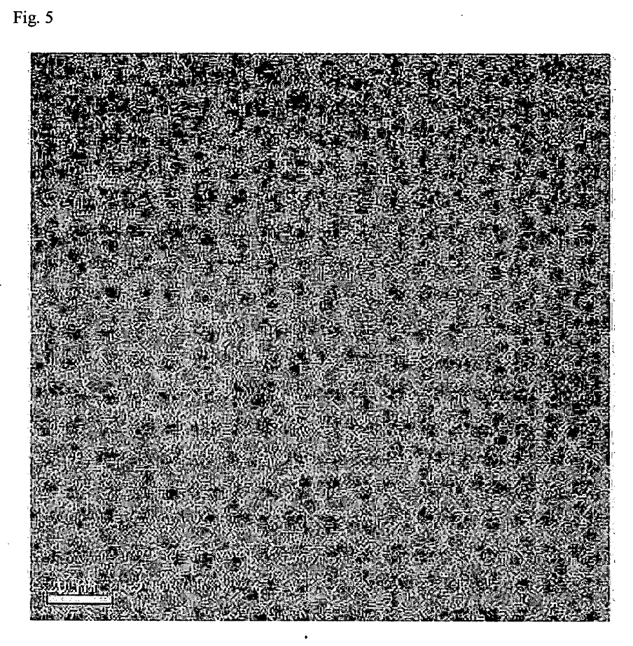

0.01M of NaOH solution dissolved in 100 ml of distilled water was added to 0.01M of palmitic (hexadecanoic) acid solution dissolved in 100 ml of methanol and agitated for 30 minutes. Here, 0.01M of AgNO₃ solution dissolved in 100 ml of distilled water was mixed gently to obtain white silver-palmitate precipitate. After isolating by filtration, the precipitate was washed 3 times with distilled water and once with methanol , followed by drying at 50° C. for 12 hours. The solid silver-palmitate complex was deposited in a Pyrex ware and heated to 260° C. for 2 hours in a vacuum oven, to produce silver nanoparticles. The result of TEM analysis of FIG. 5 ensures that silver nanoparticles having uniform size distribution with a range of 4 to 6 nm were generated.

### EXAMPLE 4

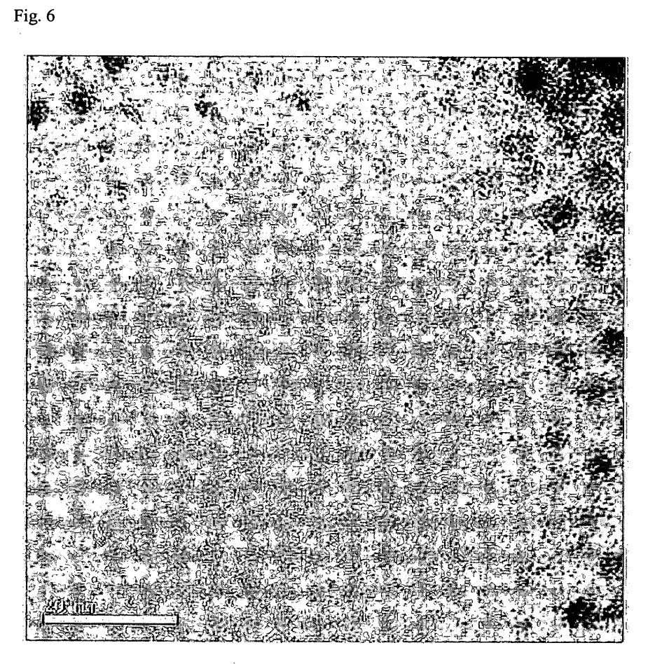

0.01M of NaOH solution dissolved in 100 ml of distilled water was added to 0.01M of palmitic acid solution dissolved in 100 ml of methanol and agitated for 30 minutes. Here, 0.01M of AgNO₃ solution dissolved in 100 ml of distilled water is mixed gently to obtain bright ivory colored silver-palmitate precipitate. After isolating by filtration, the precipitate was washed 3 times with distilled water and once with methanol, followed by drying at 50° C. for 12 hours. The solid silver-palmitate complex was deposited in a Pyrex tube, sealed up airtightly, and heated to 260° C. for 0.5 hours in a furnace, to produce silver nanoparticles. The result of TEM analysis of FIG. 6 ensures that silver nanoparticles having uniform size distribution with a range of 4 to 7 nm were generated.

### EXAMPLE 5

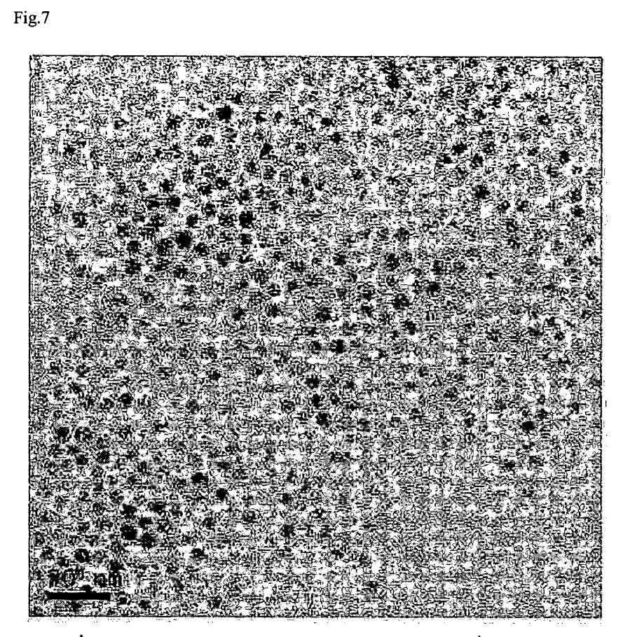

0.03M of NaOH solution dissolved in 100 ml of distilled water was added to 0.03M of myristic (tetradecanoic) acid solution dissolved in 100 ml of methanol and agitated for 30 minutes. Here, 0.03M of AgNO₃ solution dissolved in 100 ml of distilled water was mixed gently to obtain bright ivory colored silver-palmitate precipitate. After isolating by filtration, the precipitate was washed for 3 times with distilled water and once with methanol, followed by drying at 50° C. for 12 hours. The solid silver-myristeate complex was either deposited in a Pyrex ware and heated to 250° C. for 2 hours in a vacuum oven, or after deposited in a Pyrex tube and sealed up airtightly and then heated to 250° C. for 0.5 hours in a furnace, to produce silver nanoparticles. The result of TEM analysis of FIG. 7 ensures that silver nanoparticles having uniform size distribution with a range of 3 to 8 nm were generated.

Production of Conductive Ink

20 g of silver nanoparticles having 4 to 8 nm in size, produced by Examples 1 to 5, was added to a non-aqueous solvent in which the weight ratio of toluene and tetradecan is 50:50, and dispersed with an ultra-sonicator to produce 10 weight % of conductive ink. The conductive ink thus produced was spin-coated on a glass or silicon wafer and the thickness of the sheet was estimated from the coated fracture surface with SEM. The sheet resistance was also estimated with 4-point-probe, to calculate specific resistivity of the board by multiplying the sheet resistance by the thickness of the coated sheet. The results are presented in Table 1. Considering that the electrical conductivity of silver bulk is generally 5.6×105 (ohm/cm)⁻¹, it is seen that a circuit board having superior electrical conductivity may be retrieved.

TABLE 1

| | Wafer (300° C., | Glass (250° C., |
|---|---|---|
| | 30 min firing) | 30 min firing) |
| Sheet resistance (ohm/sq) | 0.187 | 0.089 |
| Thickness (μm) | 0.27 | 0.48 |
| Specific Resistivity (10⁻⁶ ohm/cm) | 5.05 | 4.27 |
| Conductivity (10⁵ (ohm/cm)⁻¹) | 2.0 | 2.34 |

As described above, the method of producing metal nanoparticles according to the present invention provides a high yield rate via a simplified process, is environment-friendly as additive solvents or supplements are not demanded, and is economical, as expensive equipments are not required.

Also, the invention provides metal nanoparticles having uniform shape and size, and may provide conductive ink including such metal nanoparticles, to have superior electrical conductivity.

1. A method of producing metal nanoparticles, said method comprising:
(a) producing a metal alkanoate by reacting a metal precursor with an alkanoate of alkali metal, alkali earth metal, or ammonium in an aqueous solution;
(b) filtrating and drying the metal alkanoate; and
(c) heat-treating the alkanoate of (b).

2. The method of claim 1, wherein the alkanoate of alkali metal, alkali earth metal, or ammonium is one or more alkanoates selected from a group consisting of Na-alkanoate, K-alkanoate, Ca-alkanoate and NH₃-alkanoate.

3. The method of claim 2, wherein the alkanoate of alkali metal, alkali earth metal, or ammonium is an alkanoate having C₈-C₁₈.

4. The method of claim 1, wherein the metal precursor is a compound including one or more metals selected from a group consisting of gold, silver, copper, platinum, indium, palladium, rhodium, ruthenium, iridium, osmium, tungsten, nickel, tantalum, bismuth, tin, zinc, titanium, aluminum, cobalt, iron and a mixture thereof.

5. The method of claim 4, wherein the metal precursor is one or more compounds selected from a group consisting of AgNO₃, AgBF₄, AgPF₆, Ag₂O, CH₃COOAg, AgCF₃SO₃ and AgClO₄.

6. The method of claim 1, wherein the heat-treating is performed at 180˜350° C. for 0.5-4 hours.

7. The method of claim 6, wherein the heat-treating is performed at one chosen from a vacuum oven, a muffle furnace, and a convection oven.

8. The method of claim 7, wherein the heat-treating is performed under nitrogen gas or air at a sealed condition.

9. Metal nanoparticles having an alkanoate chain. produced by a method of claim 1.

10. The metal nanoparticles of claim 9, wherein the size of the metal nanoparticle is 3 to 10 nm.

11. Conductive ink including the metal nanoparticles of claim 9.
